(19) United States
(12) Patent Application Publication
(10) Pub. No.: US 2014/0237193 A1
(43) Pub. Date: Aug. 21, 2014

(54) CACHE WINDOW MANAGEMENT

(71) Applicant: LSI CORPORATION, San Jose, CA (US)

(72) Inventor: Vinay Bangalore Shivashankaraiah, Bangalore (IN)

(73) Assignee: LSI CORPORATION, San Jose, CA (US)

(21) Appl. No.: 13/770,203

(22) Filed: Feb. 19, 2013

(51) Int. Cl. G06F 12/12

(52) U.S. Cl. CPC G06F 12/122
USPC 711/136

(57) ABSTRACT

A method of managing a plurality of least recently used (LRU) queues having entries that correspond to cached data includes ordering a first plurality of entries in a first queue according to a first recency of use of cached data. The first queue corresponds to a first priority. A second plurality of entries in a second queue are ordered according to a second recency of use of cached data. The second queue corresponds to a second priority. A first entry is selected in the first queue based on the order of the first plurality of entries in the first queue. A recency property associated with the first entry is compared with a recency property associated with a second entry in the second queue. Based on a result of this comparison, the first entry and the second entry may be swapped.

### BACKGROUND OF THE INVENTION

A host bus adapter (a.k.a., host controller or host adapter) connects a host system (the computer) to other network and storage devices. A host bus adapter (HBA) bridges the physical, logical, and protocol differences between the host computer's internal bus and an external communication link(s). Host bus adapters may typically contain all the electronics and firmware required to execute transactions on the external communication link. Host bus adapters may typically contain a processor, memory, and I/O such that they may be viewed as computers themselves. Thus, host bus adapters often include a firmware that not only allows the host system to boot from a device connected to the external communication link, but also facilitates configuration of the host bus adapter itself. Typically a device driver, linked to, or contained in, the operating system, controls a host bus adapter.

### SUMMARY OF THE INVENTION

An embodiment of the invention may therefore comprise a method of managing a cache, comprising: maintaining a lowest priority least recently used (LRU) queue; maintaining a plurality of higher priority (LRU) queues, each of said higher priority LRU queues having a maximum number of entries, each of said lowest priority LRU queue and said higher priority LRU queues having a least used entry; determining a first entry in a first one of said plurality of higher priority LRU queues is eligible for promotion to a second one of said plurality of higher priority LRU queues; comparing a first hit count value associated with said first entry to a second hit count value associated with a second entry of said second one of said plurality of higher priority LRU queues, said second entry being a least used entry of said second one of said plurality of higher priority LRU queues; if said first hit count value is greater than said second hit count value, swapping said first entry in said first one of said plurality of higher priority LRU queues with said second entry of said second one of said plurality of higher priority LRU queues.

An embodiment of the invention may therefore further comprise a method of managing a plurality of least recently used (LRU) queues having entries that correspond to cached data, comprising: ordering a first plurality of entries in a first queue according to a first recency of use of cached data corresponding to the respective first plurality of entries, the first queue corresponding to a first priority; ordering a second plurality of entries in a second queue according to a second recency of use of cached data corresponding to the respective second plurality of entries, the second queue corresponding to a second priority, the second priority being greater than the first priority; selecting a first entry in said first queue based on the order of said first plurality of entries in said first queue; and, comparing a recency property associated with said first entry with a recency property associated with a second entry in said second queue and based on a result of said comparison, swapping said first entry and said second entry.

### BRIEF DESCRIPTION OF THE DRAWINGS

FIG. 1 is a block diagram of a cache window management system.

FIG. 2 is an illustration of least recently used (LRU) queues.

FIG. 3 is a flowchart of a method of managing a cache.

FIG. 4 is a flowchart of a method of managing a plurality of LRU queues.

FIG. 5 is a block diagram of a computer system.

### DETAILED DESCRIPTION OF THE EMBODIMENTS

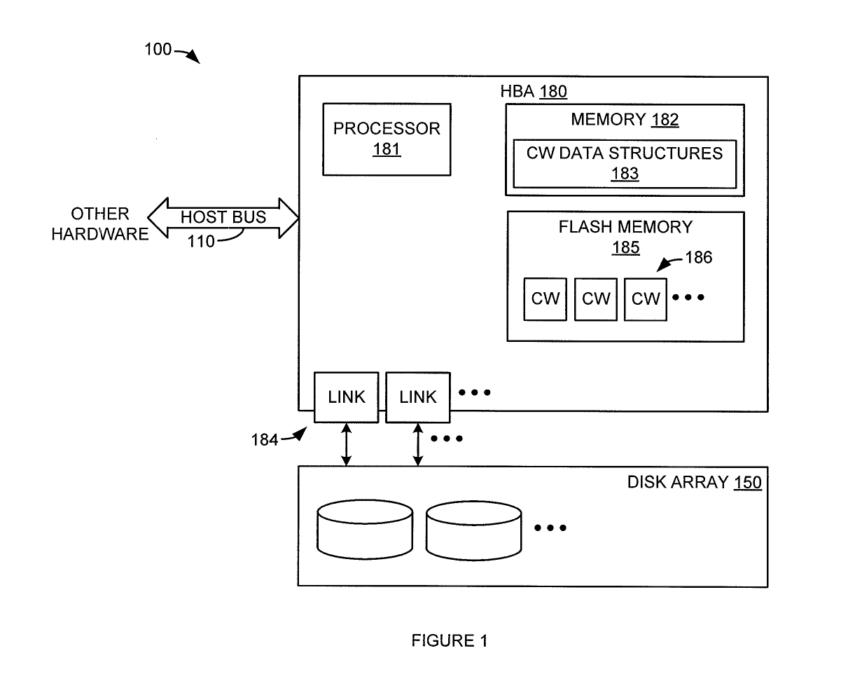

FIG. 1 is a block diagram of a cache window management system. Cache window management system 100 includes host bus adapter (HBA) 180, disk array 150. HBA 180 includes processor 181, memory 182, flash (i.e., nonvolatile) memory 185, and communication links 184. Host bus 110 operatively couples other hardware (e.g., host computer) to HBA 180. Thus, HBA 180 send and receive I/O commands and responses to/from a host computer or other hardware. HBA 180 may process I/O commands by sending/receive commands and/or responses via links 184. Host bus 110 may also be coupled to other hardware. In an embodiment, host bus 110 is a PCI-Express (PCIe) bus. In an embodiment, links 184 are serial attached SCSI (SAS) links. Links 184 operatively couple HBA 180 to at least one storage device—such as a disk drive—in disk array 150. Memory 182 holds cache window (CW) data structures 183. Flash memory 185 holds cache windows (CWs) 186.

HBA 180 can divide all or part of flash memory 185 into cache windows (CWs) 186. These cache windows 186 can be used to contain cached data based on the hotness of data on virtual disks (VDs) created by HBA 180 on the disks of disk array 150. These cache windows 186 may be, for example, 1 megabyte (MB) in size. A copy of the cache window data structures 183 are maintained memory 182. Memory 182 may be, for example, in DRAM on HBA 180. CW data structures 183 may be accessed using either a hash table or LRU list. As HBA 180 manages CWs 186, and once all the CWs 186 are consumed (i.e., contain cached data), HBA 180, using CW data structures 183, may select the least used CW 186 to use as replacement for newer hot data.

HBA 180 may further categorize the LRU list held in CW data structures 183 into priority queues. The most accessed cache windows 186 will be associated with the higher priority queues. To avoid cache windows 186 being concentrated in the highest priority queues, the promotion and demotion logic needs to be done at similar rate.

In an embodiment, HBA 180 uses an equal distribution of all available Cache Windows across all queues. For example, if there are 16,000 cache windows 186, each priority queue can be associated with, and maintain, up to 1,000 cache windows 186. An exception can be for the queue with the lowest priority (e.g, priority 0 on a scale of 0 to 15.) The lowest priority queue can be associated with all the cache windows 186. This means that any cache window 186 associated with in queue #0 is of least importance and the data in that cache window 186 can be readily swapped for newer hot data when there are no free windows.

In an embodiment, HBA 180 uses the priority queues in CW data structures 183 to track a pointer to each CW 186 and a hit count value for the highest (i.e., most recently used—MRU) and lowest (i.e., least recently used) CW 186 candidate in each priority queue. Every time a CW's 186 hit count is updated, then HBA 180 updates the corresponding priority queue's hit counters, MRU reference pointer, and LRU reference pointer. Table 1 illustrates a data structure that HBA 180 can use to track CWs 186, highest hit count value (and associated CW 186), lowest hit count value (and associated CW 186), most recently used CW 186, least recently used CW 186, and the hit count value associated with the least recently used CW 186, and some other information.

TABLE 1

| Typdef struct cc_lur_queue_ { | |
|---|---|
| list_node_t | queue; |
| uint32 | queue_length; |
| uint32 | demoted_count; |
| CW | *cw_hot_highest; |
| CW | *cw_hot_lowest; |
| CW | *cw_lru_least; |
| uint64 | cw_highest_hit_count; |
| uint64 | cw_lowest_hit_count; |
| uint64 | cw_lru_least_hit_count; |
| } cc_lur_queue_t; | |

When a cache window 186 has a hit count that crosses over a required threshold value, (e.g., 3 accesses to that CW 186 in the last N accesses processed by HBA 180) the cache window 186 will be considered for promotion to the next higher priority queue. If the next higher priority queue has space, then this cache window 186 is promoted right away by associating the CW 186 in the CW data structure 183 with the next higher priority queue. Otherwise, in an embodiment, the hit count value associated with the CW 186 under consideration is compared to the lowest hit count value of any cache window 186 in the next higher priority queue, and is compared to the hit count of the least recently used cache window 186 in the next higher priority queue's list. If one of these hit count values is larger for the candidate cache window 186, then HBA 180 will swap the entry for the candidate cache window 186 in the lower priority queue with the entry for the cache window 186 in the higher priority queue. HBA 180 then updates the lower priority queue and the higher priority queues hit counters and reference pointers accordingly. Thus, in an embodiment, HBA 180 handles demotion of a least recently used or lower hit-count weighted cache window 186 automatically when a better cache window 186 meets the conditions to be promoted.

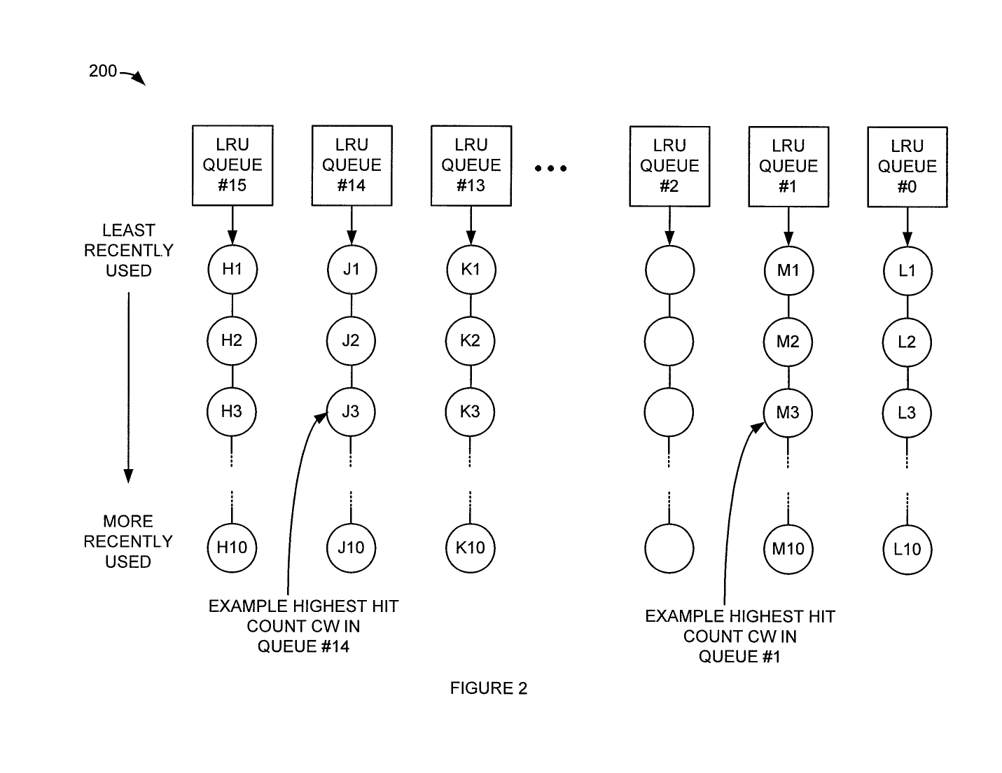

FIG. 2 is an illustration of least recently used (LRU) queues. In FIG. 2, the entries associated with cache windows in each of the LRU queues 0 to 15 are ordered from least recently used to most recently used. FIG. 2 illustrates, for example, a condition of CW data structures 183 when a cache window (i.e., L10 in FIG. 2) in queue #0 is ready for promotion. Also illustrated, for example purposes, is the condition where cache window M3 in LRU queue #1 has the highest hit count of all the cache windows associated with LRU queue #1. HBA 180 can either swap cache window L10 with the least used cache window in the next highest priority queue (i.e., cache window M1 in queue #1 as shown in FIG. 2) or the cache window with the lowest cache hit count (i.e., cache window M3 in queue #1 as shown in FIG. 2). In an embodiment, HBA 180 may use a demotion thread to move cache window H1 to queue #14, if it has not been accessed in the last demotion cycle.

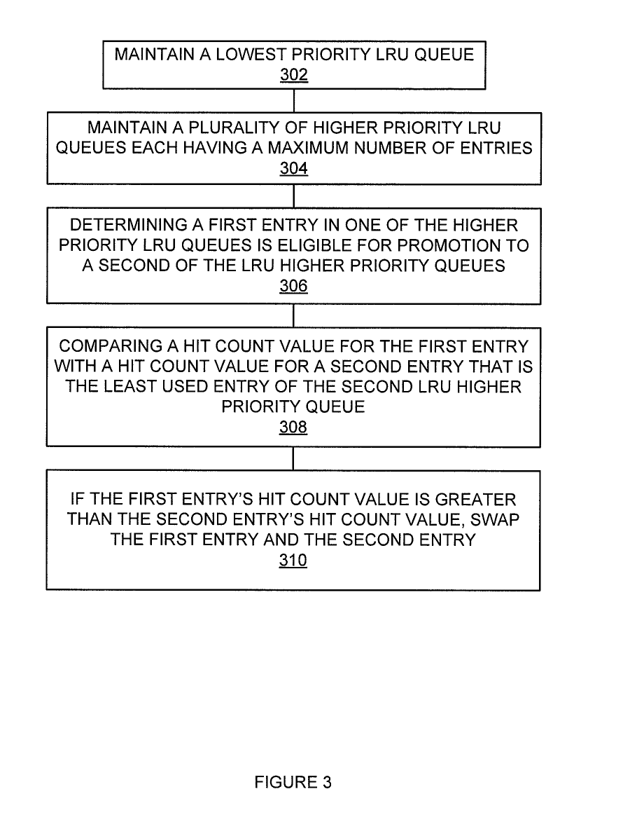

FIG. 3 is a flowchart of a method of managing a cache. The steps illustrated in FIG. 3 may be performed by one or more elements of cache window management system 100. A lowest priority LRU queue is maintained (302). For example, HBA 180 may maintain CW data structures 183 in memory 182 that associate, sort, and maintain LRU queue #0 (illustrated in FIG. 2). A plurality of higher priority LRU queues that each have a maximum number of entries are maintained (304). For example, HBA 180 may maintain CW data structures 183 in memory 182 that associate, sort, and maintain LRU queues #1 though #15 (illustrated in FIG. 2 with #15 being the highest priority and LRU queue being the lowest priority). Each of the CW data structures 183 in memory 182 associated with LRU queues #1 though #15 may be maintained in such a way as to have a maximum number of entries associated with each LRU queues #1 though #15. These maximum number of entries may be the same (e.g., 1,000) for each of LRU queues #1 though #15.

A first entry in one of the higher priority LRU queues is determined to be eligible for promotion to a second of the LRU higher priority queues (306). For example, HBA 180, may determine entry K10 in LRU queue #13 is eligible for promotion to LRU queue #14. HBA 180, may determine entry K10 in LRU queue #13 is eligible for promotion to LRU queue #14 because the cache window 186 associated with K10 has had a threshold number of accesses (hits) in a predetermined period of time.

A hit count value for the first entry is compared with a hit count value for a second entry that is the least used entry of the second LRU high priority queue (308). For example, HBA 180 may compare the hit count value of K10 with the hit count value for J1 since J1 is associated with the least recently used CW 186 in LRU queue #14. HBA 180 may compare the hit count value associated with K10 to data about LRU queue #14 maintained in the data structure given in Table 1 (e.g., cw_lowest_hit_count).

If the first entry's hit count value is greater than the second entry's hit count value, swap the first entry and the second entry (310). For example, HBA 180 may swap, in CW data structures 183, K10 and J1 if K10's hit count value is greater than J1's hit count value.

In an embodiment the first hit count value associated with the first entry may be compared to a third hit count value associated with a third entry of the second one of the plurality of higher priority LRU queues. This third entry may have the lowest hit count value of all the entries in the second one of the plurality of higher priority LRU queues. If the first hit count value is greater than the third hit count value, swapping the first entry in the first one of the plurality of higher priority LRU queues with the third entry of the second one of the plurality of higher priority LRU queues. In an embodiment, if the second one of the plurality of higher priority LRU queues (e.g., LRU queues #1-#15) do not contain the maximum number of entries allowed, HBA 180 may insert a third entry into the second one of the plurality of higher priority LRU queues. Entries in the second one of the plurality of higher priority LRU queues may be reordered such that a third entry becomes the least used entry of the second one of the plurality of higher priority LRU queues. This third entry may be removed from the second one of the plurality of higher priority LRU queues and inserted into the lowest priority LRU queue.

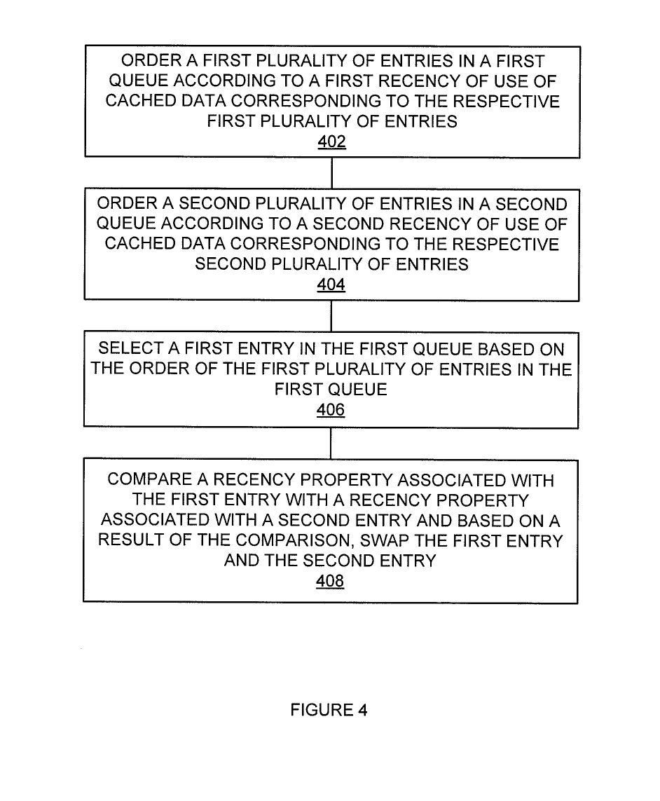

FIG. 4 is a flowchart of a method of managing a plurality of LRU queues. The steps illustrated in FIG. 4 may be performed by one or more elements of cache window management system 100. A first plurality of entries on a first queue are ordered according to a first recency of use of cached data corresponding to the respective first plurality of entries (402). For example, HBA 180 may order a entries in a first priority queue in CW data structures 183 according to the recency of use of data cached in CWs 186 that correspond to entries in that priority queue. In another example, HBA 180 may order entries K1-K10 (as shown in FIG. 2) in LRU queue #13 in CW data structures 183 according to the recency of use of data cached in CWs 186 that correspond to entries in K1-K10.

A second plurality of entries in a second queue are ordered according to a second recency of use of cached data corresponding to the respective second plurality of entries (404). For example, HBA 180 may order a entries in a second priority queue in CW data structures 183 according to the recency of use of data cached in CWs 186 that correspond to entries in that priority queue. In another example, HBA 180 may order entries J1-J10 (as shown in FIG. 2) in LRU queue #14 in CW data structures 183 according to the recency of use of data cached in CWs 186 that correspond to entries in J1-J10.

A first entry in the first queue is selected based on the order of the first plurality of entries in the first queue (406). For example, HBA 180 may select the most recently used entry in the first queue. In another example, HBA 180 may select entry K10 because it is at the more recently used end of LRU queue #13.

A recency property associated with the first entry is compared with a recency property associated with a second entry and based on a result of the comparison the first entry and the second entry are swapped (408). For example, HBA 180 may compare a recency property associated with the first entry to a recency property of an entry in the second queue. Based on the results of this comparison, HBA 180 may swap the first entry and the second entry. In another example, HBA 180 may compare a recency property of K10 with a recency property(s) of J1 and/or J3, and based on the result(s) of this comparison(s), swap K10 with J1 or J3. The recency properties compared may correspond to, for example, the number of accesses to cached data associated with the entries.

In an embodiment, a third plurality of entries in a third queue are ordered according to a third recency of use of cached data corresponding to the respective third plurality of entries. The third queue may correspond to a third priority. The third priority can be greater than the second priority. The third queue can have the maximum number of entries. A third entry in the second queue can be selected based on the order of the second plurality of entries in the second queue. The third entry may be inserted into the third queue and removed from the second queue based on a number of entries in the third queue being less than the maximum number of entries. The third plurality of entries in a third queue and the third entry can be reordered according to a fourth recency of use of cached data corresponding to the respective third plurality of entries and the third entry.

The systems described above may be implemented with or executed by one or more computer systems. The methods described above may also be stored on a computer readable medium. Many of the elements of a computer, other electronic system, or integrated circuit may be created using the methods described above. This includes, but is not limited to, cache window management system 100, bus adapter (HBA) 180, disk array 150, and/or processor 181.

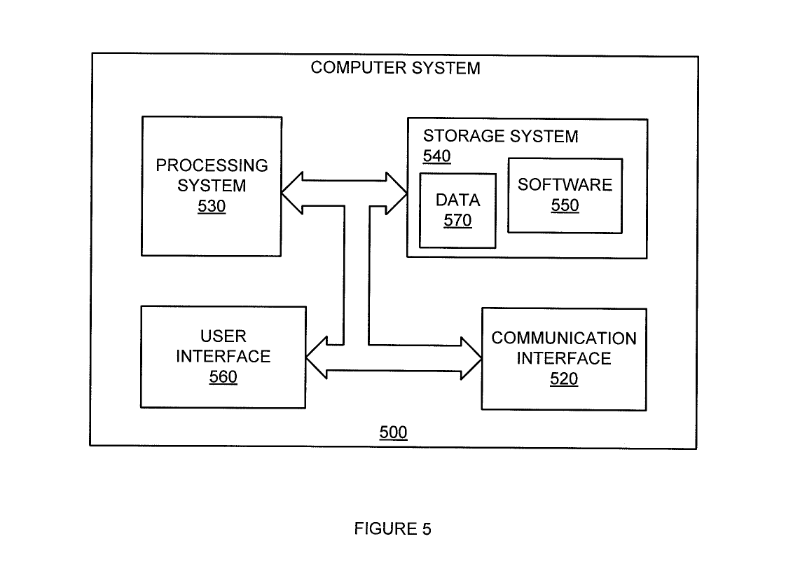

FIG. 5 illustrates a block diagram of a computer system. Computer system 500 includes communication interface 520, processing system 530, storage system 540, and user interface 560. Processing system 530 is operatively coupled to storage system 540. Storage system 540 stores software 550 and data 570. Processing system 530 is operatively coupled to communication interface 520 and user interface 560. Computer system 500 may comprise a programmed general-purpose computer. Computer system 500 may include a microprocessor. Computer system 500 may comprise programmable or special purpose circuitry. Computer system 500 may be distributed among multiple devices, processors, storage, and/or interfaces that together comprise elements 520-570.

Communication interface 520 may comprise a network interface, modem, port, bus, link, transceiver, or other communication device. Communication interface 520 may be distributed among multiple communication devices. Processing system 530 may comprise a microprocessor, microcontroller, logic circuit, or other processing device. Processing system 530 may be distributed among multiple processing devices. User interface 560 may comprise a keyboard, mouse, voice recognition interface, microphone and speakers, graphical display, touch screen, or other type of user interface device. User interface 560 may be distributed among multiple interface devices. Storage system 540 may comprise a disk, tape, integrated circuit, RAM, ROM, network storage, server, or other memory function. Storage system 540 may be a computer readable medium. Storage system 540 may be distributed among multiple memory devices.

Processing system 530 retrieves and executes software 550 from storage system 540. Processing system 530 may retrieve and store data 570. Processing system 530 may also retrieve and store data via communication interface 520. Processing system 530 may create or modify software 550 or data 570 to achieve a tangible result. Processing system 530 may control communication interface 520 or user interface 560 to achieve a tangible result. Processing system 530 may retrieve and execute remotely stored software via communication interface 520.

Software 550 and remotely stored software may comprise an operating system, utilities, drivers, networking software, and other software typically executed by a computer system. Software 550 may comprise an application program, applet, firmware, or other form of machine-readable processing instructions typically executed by a computer system. When executed by processing system 530, software 550 or remotely stored software may direct computer system 500 to operate as described herein.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of managing a cache, comprising:
maintaining a lowest priority least recently used (LRU) queue;
maintaining a plurality of higher priority (LRU) queues, each of said higher priority LRU queues having a maximum number of entries, each of said lowest priority LRU queue and said higher priority LRU queues having a least used entry;
determining a first entry in a first one of said plurality of higher priority LRU queues is eligible for promotion to a second one of said plurality of higher priority LRU queues;
comparing a first hit count value associated with said first entry to a second hit count value associated with a second entry of said second one of said plurality of higher priority LRU queues, said second entry being a least used entry of said second one of said plurality of higher priority LRU queues; and,
if said first hit count value is greater than said second hit count value, swapping said first entry in said first one of said plurality of higher priority LRU queues with said second entry of said second one of said plurality of higher priority LRU queues.

2. The method of claim 1, further comprising:
comparing said first hit count value associated with said first entry to a third hit count value associated with a third entry of said second one of said plurality of higher priority LRU queues, said third entry having a lowest hit count value of all entries in said second one of said plurality of higher priority LRU queues; and,
if said first hit count value is greater than said third hit count value, swapping said first entry in said first one of said plurality of higher priority LRU queues with said third entry of said second one of said plurality of higher priority LRU queues.

3. The method of claim 2, wherein entries in said lowest priority LRU queue and said higher priority LRU queues are associated with cached data.

4. The method of claim 1, wherein if said second one of said plurality of higher priority LRU queues does not contain said maximum number of entries, a third entry is inserted into said second one of said plurality of higher priority LRU queues.

5. The method of claim 1, further comprising:
reordering entries in said second one of said plurality of higher priority LRU queues such that a third entry becomes said least used entry of said second one of said plurality of higher priority LRU queues.

6. The method of claim 5, further comprising:
removing said third entry from said second one of said plurality of higher priority LRU queues and inserting said third entry into said lowest priority LRU queue.

7. A method of managing a plurality of least recently used (LRU) queues having entries that correspond to cached data, comprising:
ordering a first plurality of entries in a first queue according to a first recency of use of cached data corresponding to the respective first plurality of entries, the first queue corresponding to a first priority;
ordering a second plurality of entries in a second queue according to a second recency of use of cached data corresponding to the respective second plurality of entries, the second queue corresponding to a second priority, the second priority being greater than the first priority;
selecting a first entry in said first queue based on the order of said first plurality of entries in said first queue; and,
comparing a recency property associated with said first entry with a recency property associated with a second entry in said second queue and based on a result of said comparison, swapping said first entry and said second entry.

8. The method of claim 7, wherein said recency property associated with said first entry and said recency property associated with said second entry correspond to a number of accesses to cached data associated with said respective first entry and said second entry.

9. The method of claim 7, wherein said recency property associated with said first entry and said recency property associated with said second entry correspond to times when cached data associated with said first entry and said second entry were last accessed.

10. The method of claim 7, wherein said second queue has a maximum number of entries.

11. The method of claim 10, further comprising:
ordering a third plurality of entries in a third queue according to a third recency of use of cached data corresponding to the respective third plurality of entries, the third queue corresponding to a third priority, the third priority being greater than the second priority, the third queue having said maximum number of entries;
selecting a third entry in said second queue based on the order of said second plurality of entries in said second queue; and,
inserting said third entry into said third queue and removing said third entry from said second queue based on a number of entries in said third queue being less than said maximum number of entries.

12. The method of claim 11, further comprising:
reordering said third plurality of entries in a third queue and said third entry according to a fourth recency of use of cached data corresponding to the respective third plurality of entries and said third entry.

15. A non-transitory computer readable medium having instructions stored thereon for managing a cache that, when executed by a computer, at least instruct the computer to:
maintain a lowest priority least recently used (LRU) queue;
maintain a plurality of higher priority (LRU) queues, each of said higher priority LRU queues having a maximum number of entries, each of said lowest priority LRU queue and said higher priority LRU queues having a least used entry;
determine a first entry in a first one of said plurality of higher priority LRU queues is eligible for promotion to a second one of said plurality of higher priority LRU queues;
compare a first hit count value associated with said first entry to a second hit count value associated with a second entry of said second one of said plurality of higher priority LRU queues, said second entry being a least used entry of said second one of said plurality of higher priority LRU queues; and,
if said first hit count value is greater than said second hit count value, swap said first entry in said first one of said plurality of higher priority LRU queues with said second entry of said second one of said plurality of higher priority LRU queues.

16. The medium of claim 15, wherein the computer is further instructed to:
compare said first hit count value associated with said first entry to a third hit count value associated with a third entry of said second one of said plurality of higher priority LRU queues, said third entry having a lowest hit count value of all entries in said second one of said plurality of higher priority LRU queues; and,
if said first hit count value is greater than said third hit count value, swap said first entry in said first one of said plurality of higher priority LRU queues with said third entry of said second one of said plurality of higher priority LRU queues.

17. The medium of claim 16, wherein entries in said lowest priority LRU queue and said higher priority LRU queues are associated with cached data.

18. The medium of claim 15, wherein if said second one of said plurality of higher priority LRU queues does not contain said maximum number of entries, a third entry is inserted into said second one of said plurality of higher priority LRU queues.

19. The medium of claim 15, wherein the computer is further instructed to:
reorder entries in said second one of said plurality of higher priority LRU queues such that a third entry becomes said least used entry of said second one of said plurality of higher priority LRU queues.

20. The medium of claim 19, wherein the computer is further instructed to:
removing said third entry from said second one of said plurality of higher priority LRU queues and inserting said third entry into said lowest priority LRU queue.
